(19) United States
(12) Patent Application Publication
(10) Pub. No.: US 2006/0103518 A1
(43) Pub. Date: May 18, 2006

(54) Stop on time

(76) Inventor: Richard Andrew Kennell, Kalkaska, MI (US)

Correspondence Address: RICHARD KENNELL, 2100 DRIFTWOOD LN, KALKASKA, MI, 49646, US

(21) Appl. No.: 10/988,131

(22) Filed: Nov. 15, 2004

(51) Int. Cl. B60Q 1/50

(52) U.S. Cl. 340/467

(57) ABSTRACT

My invention is the state of the art in how to indicate how hard brakes are being apply to other drivers allowing them to adjust for your rate of braking.

My invention is called STOP ON TIME.

It simply indicates how hard a driver is applying his brakes to the cars behind him.

The process is made possible by mounting a vaariable resistor under the brake pedal. One end of the resistor is routed to a 12 volt supply. The other end of the resistor is sent to a string of lights which are placed in the back window of the automobile.

As the driver applies the brakes resistance to the current is decreased allowing more current to be sent to the lights in the rear window which in turn light more of the lights allowing the drivers behind you to be aware of how hard you are applying your brakes.

The idea originated in Michigan while driving in heavy traffic.

All automobiles have brake indicators but none of them give indication of how much brake is being applied which is a major concern in bumper to bumper traffic which is travelling at a high rate of speed.

STOP ON TIME will allow drivers to compensate for the rate of braking of other drivers and help prevent rear ending and traffic jams due to inadvertant braking.

The components for the units already exist in many areas and the units can easily be assembled and installed in all automobiles.

### DESCRIPTION OF OPERATION

STOP ON TIME works on the principle of varying an amperage to a load based on an applied pressure.

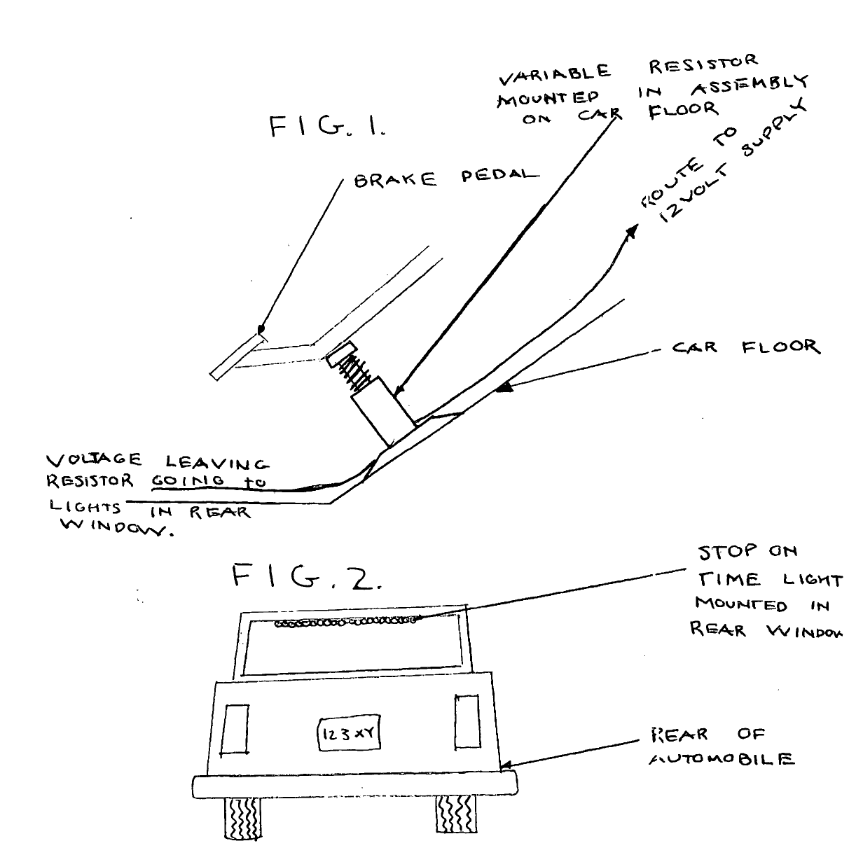

As the driver of an automobile begins to apply pressure downward on the brake pedal, a plunger located under the brake pedal is also being pushed down (see FIG. 1.). This plunger operates a variable resistor which is located between the voltage and the string of lights in the rear window (see FIG. 2.).

So as the driver pushes .on the brakes the lights in the rear window begin to light and the harder the brakes are pushed the more lights light.

1. There are many ways people have given indication that they were in the process of stopping. People have used hand signals then brake lights came along and were the state of the art indication for many years. Then manufacturers put stop indication lights in the rear windows of automobiles. But none of them have given any indication of how much brake is being applied.
Therefore my claim is the state of the art indication of hard much brake pressure is being apply while stopping and my invention is called STOP ON TIME I know of no other such type of invention as of this day Nov. 8, 2004.
